(19) United States
(12) Patent Application Publication
(10) Pub. No.: US 2009/0313047 A1
(43) Pub. Date: Dec. 17, 2009

(54) Brain Condition Assessment

(75) Inventors: Jared Brian Smith, Rockville, MD (US); William Rodman Shankle, Corona Del Mar, CA (US)

Correspondence Address: FISH & RICHARDSON, PC, P.O. BOX 1022, MINNEAPOLIS, MN, 55440-1022, US

(73) Assignee: MEDICAL CARE CORPORATION, Irvine, CA (US)

(21) Appl. No.: 12/140,202

(22) Filed: Jun. 16, 2008

(51) Int. Cl. G06Q 50/00

(52) U.S. Cl. 705/3

(57) ABSTRACT

Methods, systems, and apparatus, including medium-encoded computer program products, for creating an indication of brain condition include: receiving first information concerning a person, the first information indicating presence or absence of markers for an aspect of an assessment performed for the person, the aspect occurring at least twice at respective portions of the assessment; generating an indication of brain condition for the person by comparing the first information with second information concerning a group of people for whom the assessment has been performed, where the comparing includes checking a conditional probability of finding the marker present for the aspect of the assessment in one of the portions of the assessment when the marker is present for the aspect in another of the portions of the assessment; and outputting the indication of brain condition for the person.

### BACKGROUND

This specification relates to assessing the brain condition of a person, such as can be done based on results of a cognitive test that has been administered to the person.

Various techniques have been used to measure the cognitive function of a person. For example, the National Institute of Aging's Consortium to Establish a Registry of Alzheimer's Disease (CERAD) has developed a ten word list as part of the Consortium's neuropsychological-battery. The CERAD word list (CWL) test consists of three immediate-recall trials of a ten word list, followed by an interference task lasting several minutes, and then a delayed-recall trial with or without a delayed-cued-recall trial. The CWL is usually scored by recording the number of words recalled in each of the four trials. A single cutoff score for the delayed-recall trial, with or without adjustment for demographic variables, is typically used to determine whether cognitive impairment exists for a given subject.

Some have proposed various improvements to the CWL. In addition, the CWL and the improvements thereof have been used to provide memory performance testing services, via the Internet, to clinicians in daily practice. Such services allow rapid testing of individual patients and reporting on the results of such testing. Previous reports for individual cognitive performance test results have included a statement of whether the patient has been found to be normal or to have cognitive impairment.

### SUMMARY

This specification describes technologies relating to assessing the brain condition of a person, such as can be done based on results of a cognitive, functional or behavioral test that has been administered to the person. Conditions of the brain that can be assessed using the present systems and techniques include, but are not limited to, general cognitive function (e.g., assessing the likelihood of mild cognitive impairment), disorder classification (e.g., assessing whether a decline in cognitive impairment is likely caused by a progressive or static disorder of the body or brain), and specific types of neurological disease (e.g., Alzheimer's, Parkinson's, or vascular disease).

In general, an aspect of the subject matter described in this specification can be embodied in one or more methods that include receiving first information concerning a person, the first information indicating presence or absence of markers for an aspect of an assessment performed for the person (e.g., sufficiency, or lack thereof, of the person's responses to an aspect of a cognitive test administered to the person), the aspect occurring at least twice at respective portions of the assessment; generating an indication of brain condition for the person by comparing the first information with second information concerning a group of people for whom the assessment has been performed, where the comparing includes checking a conditional probability of finding the marker present for the aspect of the assessment in one of the portions of the assessment when the marker is present for the aspect in another of the portions of the assessment (e.g., conditional probability of a sufficient response in one portion when a sufficient response has been provided for the same aspect in another portion); and outputting the indication of brain condition for the person. The assessment can be designed to collect subjective information (e.g., in the form of a questionnaire) or objective information (e.g., in the form of a test). The assessment can address various types of information, including diagnostic test data (e.g., deoxyribonucleic acid (DNA) data), functional capacity data (e.g., data regarding the person's functional activities of daily living), behavioral data (e.g., data regarding the person's typical and/or exemplary behaviors), and cognitive function data (e.g., the subject's ability to recall specific information after being told such information).

Accordingly, another aspect of the subject matter described in this specification can be embodied in one or more methods that include receiving first information concerning a person, the first information specifying the person's responses, and lack thereof, for items of a cognitive test administered to the person, where the cognitive test includes multiple item-recall trials and includes at least one item common to a subset of the recall trials, the subset including at least two of the recall trials; generating an indication of brain condition for the person by comparing the first information with second information concerning a group of people to whom the cognitive test has been administered, where the comparing includes checking a conditional probability of recalling the at least one item in one recall trial of the subset when the at least one item has been recalled in another recall trial of the subset; and outputting the indication of brain condition for the person. Other embodiments of this aspect include corresponding systems, apparatus, and computer-readable media encoding computer program product(s) operable to cause data processing apparatus to perform the operations.

These and other embodiments can optionally include one or more of the following features. The method can include determining a recall pattern for each of multiple items across the recall trials, where the comparing includes evaluating a probability of the recall patterns for the person given probabilities of the recall patterns for the group of people. Generating the indication of brain condition for the person can include choosing between evaluation techniques based on response tuples that discriminate between a first condition and a second condition of the brain, where the choosing can include: estimating, for each response tuple, a first tuple probability associated with the first and second conditions based on a high sensitivity cut-point applied to the second information; evaluating, for each individual in a sample, a first individual probability associated with the first and second conditions based on the first tuple probabilities for response tuples associated with the individual; estimating, for each response tuple, a second tuple probability associated with the first and second conditions based on a high specificity cut-point applied to the second information; evaluating, for each individual in the sample, a second individual probability associated with the first and second conditions based on the second tuple probabilities for response tuples associated with the individual; and selecting, between evaluation based on the high sensitivity cut-point and evaluation based on the high specificity cut-point, based on whether the first individual probabilities or the second individual probabilities provide better predictive performance. Moreover, the estimating the first tuple probability and the estimating the second tuple probability can be performed with respect to a proper subset of the second information, and the sample can include an independent sample taken from the second information, excluding individuals in the proper subset.

The first condition can include mild cognitive impairment, the second condition can include normal cognitive function, and generating the indication of brain condition can include generating a cognitive function measure that indicates whether the person is likely to have mild cognitive impairment. The first condition can include mild dementia, the second condition can include normal cognitive function, and generating the indication of brain condition can include generating a cognitive function measure that indicates whether the person is likely to have mild dementia. The first condition can include mild dementia, the second condition can include mild cognitive impairment, and generating the indication of brain condition can include generating a cognitive function measure that indicates whether the person is likely to have mild dementia mild dementia versus mild cognitive impairment.

Particular embodiments of the subject matter described in this specification can be implemented to realize one or more of the following advantages. The assessment of a brain condition can be improved by measuring an individual's pattern of recalling a given test item (e.g., a word) across testing trials, as compared with a group of people to whom the same cognitive test has been administered. Each word in a wordlist can be scored according to its pattern of being recalled, or not recalled across each trial of the cognitive test. For example, each word in the CWL can be scored across any combination of five trials, which include three immediate and one delayed free recall trials, plus a delayed recognition trial. The described systems and techniques can also be used in tests in which the number of words to which the subject is exposed in each trial varies, as well as in tests in which the subject can be exposed to any given word more than once in a given trial. The resulting indication of brain condition can be used in conjunction with other assessment programs (e.g., a cognitive function scoring program) to improve overall accuracy, sensitivity and specificity. Moreover, the described systems and techniques can be used to provide greater stability of classification performance over a more diverse population of subjects.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example system used to create an indication of brain condition for a person to whom a cognitive test has been administered.

FIG. 2 shows an example process used to assess brain condition by checking a conditional probability of recalling an item across multiple trials of a cognitive test.

FIG. 3 shows another example process used to assess brain condition.

FIG. 4 shows an example process of identifying one or more response tuples that discriminate between a first condition and a second condition of the brain.

FIG. 5 shows another example system used to create an indication of brain condition.

### DETAILED DESCRIPTION

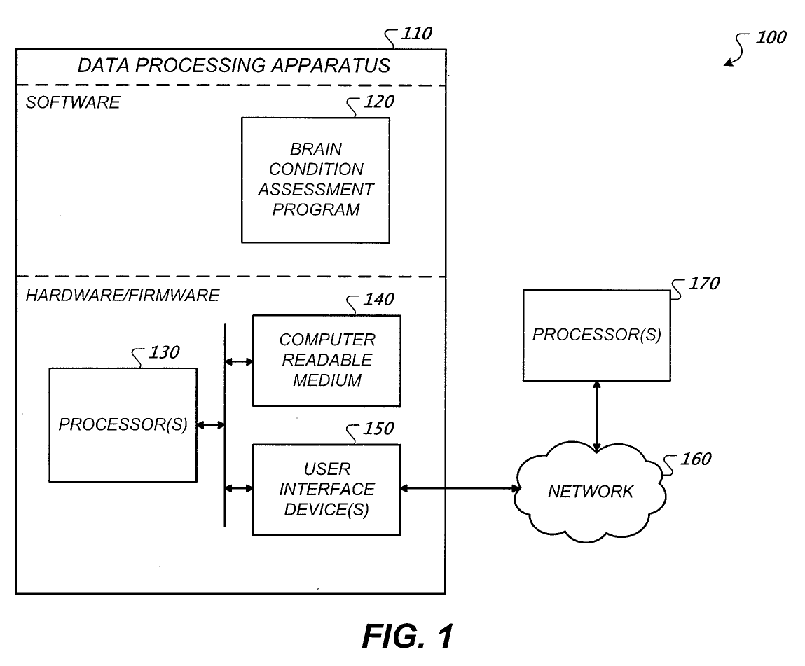

FIG. 1 shows an example system 100 used to create an indication of brain condition for a person. A data processing apparatus 110 can include hardware/firmware and one or more software programs, including a brain assessment program 120. The brain assessment program 120 operates in conjunction with the data processing apparatus 110 to effect various operations described in this specification. The program 120, in combination with the various hardware, firmware, and software components of the data processing apparatus, represent one or more structural components in the system, in which the algorithms described herein can be embodied.

The program 120 can be an application for determining and performing analysis on data collected to assess a brain condition of a subject. An application refers to a computer program that the user perceives as a distinct computer tool used for a defined purpose. An application can be built entirely into an operating system or other operating environment, or it can have different components in different locations (e.g., a remote server). The program 120 can include or interface with other software such as database software, testing administration software, data analysis/computational software, and user interface software, to name a few examples. User interface software can operate over a network to interface with other processor(s). For example, the program 120 can include software methods for inputting and retrieving data associated with a cognitive assessment test, such as score results, or demographic data. The program 120 can also effect various analytic processes, which are described further below.

The data processing apparatus includes one or more processors 130 and at least one computer-readable medium 140 (e.g., random access memory, storage device, etc.). The data processing apparatus 110 can also include one or more user interface devices 150. User interface devices can include display screen(s), keyboard(s) a mouse, stylus, modems or other networking hardware/firmware, or any combination thereof to name a few examples. The subject matter described in this specification can also be used in conjunction with other input/output devices, such as a printer or scanner. The user interface device can be used to connect to a network 160, and can furthermore connect to a processor or processors 170 via the network 160 (e.g., the Internet).

Therefore, a user of the assessment program 120 does not need to be local, and may be connecting using a web browser on a personal computer, or using other suitable hardware and software at a remote location. For example, a clinician at a testing center can access a web interface via the remote processor 170 in order to input test data for a cognitive test. The test data can be the results of an already administered test, or the test data can be the information exchanged when actually administering the cognitive test using a network based testing system. In any event, data can be transmitted over the network 160 to/from the data processing apparatus 110. Furthermore the clinician can input test data and retrieve analysis based on that data or other data stored in a database. Note that the data processing apparatus 110 can itself be considered a user interface device (e.g., when the program 120 is delivered by processor(s) 170 as a web service).

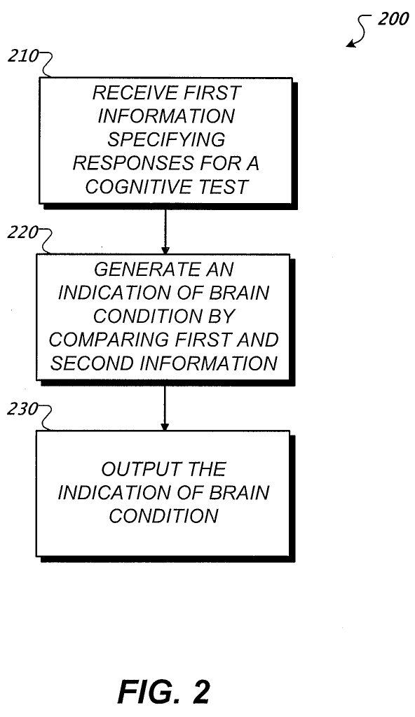

FIG. 2 shows an example process 200 used to assess brain condition by checking a conditional probability of recalling an item across multiple trials of a cognitive test. First information is received 210, where the first information specifies responses, and lack thereof, for items of a cognitive test administered to a person. As noted above, the information can be from a previously administered test or from a test that is currently being administered. Nonetheless, the example process described in connection with FIG. 2, and other implementations of the more general concepts underlying this example process, are not practiced on the human body since such processes do not themselves involve an interaction necessitating the presence of the person.

The cognitive test can include multiple item-recall trials and at least one item common to a subset of the recall trials, where the subset includes at least two of the recall trials. In general, the full set of information in the test should be recorded, including all components of the test and all subject responses. The information can be received 210 from a database, a network or web-enabled device, a computer readable medium, or a standard input output device on a computer system, to name just a few examples. The cognitive test can include a test of attention and recall, and the test components can include items (e.g., words) to be recalled in one or more trials. For example, a test of attention and recall can include the CERAD word list (CWL) and/or other lists of words or items.

The CWL is a test of immediate and delayed free recall and delayed cued recall that was developed by the National Institute of Aging CERAD centers in the 1980s. There are three learning trials in which the subject is presented each word in the list and repeats it, then at the end of the list, recalls as many words as they can. The subject is not instructed to recall the words in the order they are presented, but rather to recall as many words as they can immediately after being presented the list of ten words. They are also instructed that a few minutes after the third learning trial they will again be asked to recall as many of the words as they can without another presentation of the words. The words are presented in a different order for each learning trial. The number of words correctly recalled is recorded for each of the three learning trials. After the third learning trial, an interference task that distracts the subject from rehearsing the word list (e.g., a test of executive function) is given over a period of two to five minutes. After the interference task, the subject is asked to recall as many of the ten words as they can (delayed free recall trial). The number of words correctly recalled is recorded. After the delayed free recall trial, the subject is given a delayed recognition task. The subject is presented the ten CWL words intermixed with ten distracter words. For each word, the subject is asked whether it was one of the CWL words, and the subject's response (yes or no) is recorded.

Since the words of the trials are already known, the first information need not specify the words themselves, but rather just whether or not a given word was recalled. For example, eight word lists can be used, with each word list including ten words for learning and recall, plus ten more words for delayed-cued-recall. Four trials can be employed in the cognitive test, where one of the eight word lists can be selected for use in the test. The first set of ten words from the list can be used in the immediate and delayed free recall trials (and the words of the list can be presented in the same order in each trial or in a different order), and the second set of ten words can be used as the distracter word list for the delayed-cued-recall trial. The first information can include an eighty column binary score (i.e., an eighty bit vector) that corresponds to the responses received on the immediate and delayed free recall trials of the cognitive test. Each bit in this example indicates whether a corresponding word from a trial was recalled, or whether the corresponding word from the trial was not recalled.

For example, an eighty columns wide binary indicator matrix can be defined as follows. Each word in each trial can occupy 2 columns. The first column can be assigned a 1 if the word in the trial was recalled and a 0 if it was not recalled. The second column can be assigned a 0 if the word in the trial was recalled and a 1 if it was not recalled. Each trial with ten words thus occupies twenty columns for a total of eighty columns for the four free recall trials of the word list trials. With this arrangement, the binary indicator matrix gives a row total of forty, which permits the determination of an optimal column score for a word when it was recalled in a trial, as well as a different optimal column score when that word was not recalled in a trial.

The words in each word list can be linguistically and statistically equivalent. The words on each distinct list can have the same level of intra-list associability and usage frequency. Each list of words can have the same level of associability and usage frequency with each and every other list of words. For example, the eight word lists used can be as shown in Table 1:

TABLE 1
Word List

| | List 1 | List 2 | List 3 | List 4 | List 5 | List 6 | List 7 | List 8 |
|---|---|---|---|---|---|---|---|---|
| W1 | BUTTER | BEDROOM | CAKE | CLOCK | BIBLE | OAK | JAZZ | BAT |
| W2 | ARM | DOWN | PARK | SCALE | FEMALE | RANK | BUS | SAFETY |
| W3 | SHORE | MESSAGE | WISDOM | THREAT | LEGEND | TASTE | LID | COPY |
| W4 | LETTER | BIRTHDAY | MARRIAGE | SPORT | STAMP | SPRING | CRITIC | ROOF |
| W5 | QUEEN | WIND | REST | SPACE | TOOTH | BRAND | DARK | ACTOR |
| W6 | CABIN | TRUCK | NOTICE | LAYER | FAT | PROJECT | OWNER | VISIT |
| W7 | POLE | LEADER | BOAT | AMOUNT | GLOVE | SERVANT | GUEST | POOL |
| W8 | TICKET | HAT | PLANET | FLOOD | LECTURE | CUP | WEATHER | GRIEF |
| W9 | GRASS | BARN | KNEE | DOUBLE | BEAST | LIST | PEACE | SLEEVE |
| W10 | ENGINE | SOCK | TELEPHONE | RESPECT | AGENT | PLAIN | BASE | OUTCOME |
| D1 | CHURCH | WINTER | BLANKET | TOUCH | SHOW | CAMP | MUSCLE | DANCE |
| D2 | COFFEE | BAG | VEIN | FLOOR | CASH | BATHROOM | ORGAN | REGION |
| D3 | DOLLAR | BLUE | SHAPE | LEATHER | HELICOPTER | OIL | WEDDING | SMOKE |
| D4 | FIVE | ROOT | NEWSPAPER | ARROW | FLOWER | EARTH | WOOD | BLADE |
| D5 | HOTEL | TRAIL | MISSION | KID | NUT | BEEF | SUPPORT | STRESS |
| D6 | MOUNTAIN | SEED | WATCH | BUCKET | SILVER | LUNCH | PARKING | LIMIT |
| D7 | SLIPPER | HEART | LIGHT | CONFLICT | BOTTLE | PORTRAIT | BRANCH | TRIAL |
| D8 | VILLAGE | SOUP | PINT | DUST | LOYALTY | HOST | PHOTO | PENCIL |
| D9 | STRING | NOISE | CYCLE | PRESSURE | LOAD | STRUGGLE | VERSE | WIFE |
| D10 | TROOP | CREATURE | MOUTH | SPELL | DECADE | RIDE | LOUNGE | PLAYER |

W#: 10 Word List used in learning trial to be recalled
D#: Used in Delayed-Cued-Recall Trial along with the 10 Word List

The word lists can be used in different parts of a test (e.g., the distracter and learning word lists can be interchanged). Moreover, the words in each word list can be presented in the same order or different order. For example, a shuffled order can be employed over multiple trials, such as in the CERAD or the ADAS-Cog (Alzheimer's Disease Assessment Scale-cognitive subscale) cognitive assessment tools. ADAS-cog consists of eleven tasks measuring different cognitive functions. The ADAS-Cog word recall test has the same general method of test administration as the CWL. Note that the ADAS-Cog but does not use the 10-word list for cued recall that is used in the immediate and delayed free recall trials. It has its own set of words for that.

In general, the words in each word list should have the same difficulty of being recalled as the other words on that list, as well as the words in the other lists. For each learning trial, the words can be presented in the same order or in different order. It will be appreciated that other data formatting approaches, as well as other cognitive tests and test components, are also possible.

Other cognitive assessment tests can include, but are not limited to other multiple word recall trials, other recall or cued recall tests of verbal or non-verbal stimuli, tests of executive function, including triadic comparisons of items, (e.g., deciding which one of three animals is most different from the other two), tests of judgment, similarities, differences or abstract reasoning, tests that measure the ability to shift between sets or perform complex motor sequences, tests that measure planning and organizational skill, tests of simple or complex motor speed, tests of language abilities including naming, fluency or comprehension, tests of visual-perceptual abilities including object recognition and constructional praxis. Examples of recorded data can include the words recalled, the words not recalled, the order of the words recalled, time delay before recall, the order in which intrusions and repetitions are recalled, and various aspects of test performance. Moreover, the cognitive test can include one or more trials performed to determine specific cognitive functions such as physical (e.g. orientation or hand-eye coordination) or perception based tests. Additional information can be obtained in order to classify the score, such as demographic information, or the date(s) of test administration, to name just two examples.

In any event, the cognitive test includes multiple item-recall trials and includes at least one item common to a subset of the recall trials, where the subset includes at least two of the recall trials. This is because the present systems and techniques involve measuring the pattern of recalling a given item (e.g., a word) across testing trials. Such information can help to distinguish between various brain conditions, such as distinguishing between mild cognitive impairment and normal aging. For example, a normal subject who recalls the word “butter” on trials one and two, may have a higher probability of recalling the word “butter” on trial three than a subject with mild cognitive impairment or dementia.

An indication of brain condition is generated 220 for the person. This involves comparing the first information with second information concerning a group of people to whom the cognitive test has been administered, where this comparing includes checking a conditional probability of recalling the at least one item in one recall trial of the subset when the at least one item has been recalled in another recall trial of the subset. In general, the recall patterns (across trials) for an individual being assessed are compared with known recall patterns for a group of people whose brain conditions are already established to a desired level of accuracy. Given the second information for the group of people, a good estimate of the conditional probability of recalling the at least one item in one recall trial of the subset when the at least one item has been recalled in another recall trial of the subset is known for each brain condition of interest. This information can be compared with an individual's recall pattern(s) to generate the indication of brain condition for the current individual.

The second information for the group of people can be a set of well-classified cases generated in the following manner. A relatively large population of subjects can be evaluated with an extensive neuropsychological test battery, with functional measures, with severity staging measures (the Clinical Dementia Rating Scale, the Functional Assessment Staging Test, and/or other measures), with laboratory testing and brain imaging. The evaluated population is “relatively large” in the sense that there are enough cases to provide statistically significant results in light of the number of modeled categories, e.g., over four hundred subjects when the number of tuple categories (discussed further below) is sixteen. The evaluated population should include normal subjects and subjects with one or more brain conditions of interest, such as mild cognitive impairment, mild dementia, moderate dementia, severe dementia, Alzheimer's disease, Parkinson's disease, vascular disease, etc. Standardized criteria can be used to classify these subjects with respect to the various brain conditions. If mild cognitive impairment or dementia is found, then standardized diagnostic criteria can be used to identify the underlying cause.

Correspondence analysis can be used to analyze the cognitive test results for the subjects (e.g., the binary score vectors of the training sample), and to compute the optimal row score matrix, optimal column score matrix and the singular value matrix. Correspondence analysis is an analytical method that has been largely used in quantitative anthropology and the social sciences. Its primary function is to maximize the canonical correlation between the rows and columns of an input data matrix so that the maximum amount of information in the data can be explained. Mathematically, it is designed to provide the best linear solution to the explanation of the information (variance) in the data.

In some embodiments, correspondence analysis can be used to maximize the explanation of the information that distinguishes individuals with different brain conditions (e.g., normal or cognitively impaired). In the case of the CWL, the information consists of the patterns of recalled plus non-recalled words in each trial. In this sense, subject scores generated by correspondence analysis represent a complex combination of the subject characteristics (both normative and non-normative) plus word list test performance metrics (e.g., words recalled, order recalled, retention time, etc.). The maximization of the explainable information can be accomplished through a singular value decomposition of the input data matrix.

Correspondence analysis reduces the dimensionality of a raw data matrix while minimizing the loss of information. Tschebychev orthogonal polynomials can be used to convert the raw data matrix into an optimal row score matrix, an optimal column score matrix, and a singular value matrix of eigenvalues. These matrices can have the following statistical properties: (1) each row of the optimal row score matrix consists of a vector whose components are multivariate, normally distributed and statistically independent of each other; (2) the optimal row score vectors are also directly comparable because the effects of their marginal totals have been removed; (3) each column of the optimal column score matrix consists of a vector whose components are multivariate, normally distributed and statistically independent; (4) the optimal column score vectors are also directly comparable because the effects of their marginal totals have been removed; (5) the singular value matrix consists of a vector along the diagonal of the matrix, in which each value represents a canonical correlation between the row and column variables of the optimal score matrices. Each value of the vector is statistically independent of the other values, and indicates the magnitude of the contribution of each component of the optimal row and column score vectors; the rank of these three matrices defines the number of statistically independent components needed to account for all of the explainable variance (non-noise) in the raw data. The rank is usually of much lower dimension than the number of rows or columns. This means that the transformation of the input data matrix into a set of statistically orthogonal matrices (via singular value decomposition) can yield a massive reduction in dimensionality while continuing to account for most of the explainable information in the input data.

Thus, the optimal row scores represent the pattern of both recalled and not recalled words in each trial after removing the effect of the total number of words recalled, and the optimal column scores represent the effects of recalling or not recalling a given word in a given trial after removing the effect of the sample distribution. In this regard, the optimal row and optimal column scores are not simple weightings of the number of words recalled, their difficulty, their order or their position in the wordlist, or the specific sample used. Rather, the optimal row and column scores provide the best linear solution to explaining the total variance (information) of the raw data.

Correspondence analysis can thus produce optimal row and column score vectors that only require a relatively small number of components (the first two or three components in many cases) to characterize the majority of the explainable variance of the input data matrix. These optimal row and column score vectors can be derived by the simultaneous and inseparable use of the information from both normative and non-normative cases as well as recalled and non-recalled words per trial to maximize data reduction and explanation of the total variance. The optimal column score and singular value matrices can be used for classification of future subjects, while the optimal row score matrix can be used to develop a statistical classification algorithm, such as one using logistic regression or discriminant analysis.

Various different cognitive tests and cognitive function scoring techniques can be used. In any event, the cognitive test data can be analyzed to generate the indication of brain condition for a person being assessed, such as using the techniques described further below, and the indication of brain condition is output 230 as needed. The indication can be a Boolean indication or a number, such as a measure of probability. Thus, the indication represents intermediate information that has diagnostic relevance, which can be used by a doctor to make a diagnosis, or can be used as input to other processes.

Outputting the indication can involve displaying or printing the indication to an output device, or saving the indication in a computer-readable medium for use as input to further assessment programs. For example, the saved indication can be used in adjusting a cognitive function score generated using a logistic regression algorithm; or the saved indication can be used in classifying various aspects of brain condition, such as classifying cognitive impairment by level of severity, classifying dementia by level of severity, classifying cognitively related functional impairment by level of severity, or classifying cognitive impairment or dementia by underlying cause (e.g., Alzheimer's Disease, Lewy Body Disease, Cerebrovascular Disease, etc.), provided that well characterized samples of cases of specific types are used.

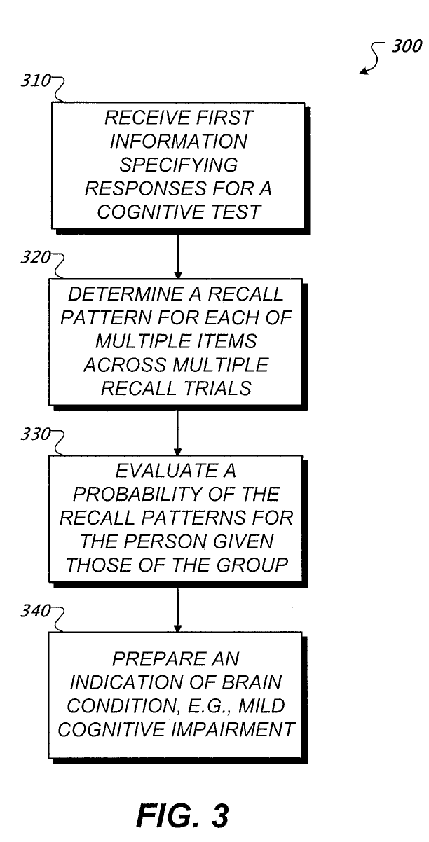

FIG. 3 shows an example process 300 used to assess brain condition. As before, first information is received 310, where the first information specifies responses, and lack thereof, for items of a cognitive test administered to a person. As noted above, the items learned and tested need not be words. However, the present disclosure focuses on the case of the items being words, in the context of the CWL. This is done for purposes of clarity in this disclosure and in no way limits the application of the systems and techniques described to these specific examples. In general, the described systems and techniques can be used in any cognitive test in which the pattern of recall of an item across testing trials can be measured. Moreover, the described systems and techniques can allow for variations in: (1) the number of learning trials; (2) the number of testing trials; (3) the types of learning trials used (e.g., presenting items visually or audibly, verifying or not verifying that the subject correctly registered or understood the item presented, providing cues for items not recalled, learning trials in which the subject is presented only items not recalled in the previous learning trial); (4) the types of testing trials (e.g., delayed cued recall vs. delayed recognition vs. delayed free recall, delayed free recall plus providing cues for items not recalled); (5) the number of items in the test list; (6) the number of items presented from the test list in each learning trial; and (7) the types of items presented in the test list (e.g., items presented as words, pictures or other visual displays, sounds, smells, tastes, and items presented by touching them).

A recall pattern can be determined 320 for each of multiple items across the recall trials. For example, subject test performance can be captured in the following form; let:

$${d}_{ijk} = \{ \begin{matrix}1 & if individual i responds correctly to item j on trial k \\ 0 & if individual i responds incorrectly to item j on trial k\end{matrix}$$

Then, the basic scoring element for the subject can be the response vector:

zᵢⱼ=(dᵢⱼ₁, dᵢⱼ₂, . . . , d_{ijK})

where K is the total number of trials. There are 2^{K} possible response tuples for each word. For the CERAD Wordlist, there are 16 (2⁴) response tuples for each list word. Each of the 2^{K} possible response tuples per word is assigned a unique response tuple value, c, which, for a given subject's recall of that word across K trials is:

$$c = {\sum }_{k = 1}^{K} ( {2}^{k} {d}_{ijk} )$$

Given a response tuple, c, the data can be coded as follows:

$${x}_{ijc} ≡ \{ \begin{matrix}1 & if c is the item j response tuple for subject i \\ 0 & Otherwise\end{matrix}$$

As will be appreciated, this approach allows the response tuple value, c, to be used as a binary address within a computer system to access x_{ijc}, thus enabling more efficient processing. In any event, the goal can then be to identify response tuples that optimize discrimination between two different brain conditions, such as discriminating between normal and impaired individuals.

Many different types of classification algorithms can be applied to such data, including correspondence analysis, ordinal logistic regression, Bayesian hierarchical methods, and classification and regression trees. The example detailed below is based on discriminant analysis.

A probability of the recall patterns for the person can be evaluated 330, given probabilities of the recall patterns for the group of people. For example, suppose that for a given population, each word has a fixed set of probabilities of falling into the 2^{K} response tuples. Namely, for a given word, j, the prior probability response tuple vector, p_{jc}, of all possible response tuples is:

P(x_{ijc}=1)=pⱼ→Multinomial(1;pⱼ₁, pⱼ₂, . . . , p_{jC})

Note that pⱼ is the prior probability response tuple vector that would be assigned to any subject for the given word, j, until more information is known (such as the subject's performance for word j). Next, let the set consisting of the prior probability response tuple vectors for all list words be defined as the prior probability response tuple profile, p, which equals <p_{1c}, p_{2c}, . . . , p_{Jc}>_{c=1}^{C}. The implicit presumption here is that each word's probability of recall is independent of the other list words, which is why the words in a learning list need to have low associability.

When a subject has performed the specified number of trials, K, one can then compute their posterior probability response tuple profile, which is:

$$P ( {D}_{i} \vert p ) = {\prod }_{j = 1}^{M} {\prod }_{c = 1}^{C} {p}_{j}^{{x}_{ijc}}$$

Dᵢ=<x_{ijc}>ⱼ₌₁^{M}, represents the ith subject's response tuple for each of the M list words, and pⱼ is the jth probability response tuple vector for list word j across the K selected trials. Note that the term, x_{ijc}, equals 1 only for the response tuples, p_{jc}, that characterize the recall performance of the given subject, i, across the list words.

An indication of brain condition is prepared 340. For example, the group membership of subject i (e.g., normal vs. impaired) can be defined by an indicator variable, aᵢ where:

$${a}_{i} = \{ \begin{matrix}1 & if subject i is impaired \\ 0 & if subject i is normal\end{matrix}$$

Bayes theorem can be used to classify the subject to a particular group by evaluating the probability of their response tuple profiles given the probabilities of their response tuples:

$$P ( {a}_{i} = 1 \vert {D}_{i} ) = \frac{P ( a = 1 ) P ( {D}_{i} \vert a = 1 )}{P ( a = 1 ) P ( {D}_{i} \vert a = 1 ) + P ( a = 0 ) P ( {D}_{i} \vert a = 0 )} \qquad ( 1 )$$

Where P(aᵢ=1) and P(aᵢ=0) can be interpreted as the prior probability of membership to impaired and normal groups respectively. In equation (1), the reliability of classifying a given subject into the proper group depends upon the accuracy of the estimates of the response tuples, c, that are most relevant to group discrimination. If there is a sufficiently large data set where the group membership, a, is known, then the estimated probability of belonging to a given group, a (e.g., normal or impaired), for a given response tuple, c, and a given word, j, can be given by:

$${\hat{p}}_{jca} = \frac{{\sum }_{i = 1}^{N} {a}_{i} ( {x}_{ijc} = c )}{N} \qquad ( 2 )$$

for a=0, 1 groups; i=1, . . . , N subjects; c=1, 2, . . . , 2^{K} response tuples; j=1, 2, . . . M words. Note that the term aᵢ(x_{ijc}=c) is set equal to “1” for all subjects belonging to the group being estimated. The group being estimated is made up of those individuals whose recall pattern of the word, j, corresponds to the unique response tuple specified by the value, c, across the specified set of K trials.

Since the number of response tuples for any given word increases exponentially with the number of trials, large samples may be needed to obtain reliable estimates of the response tuple profiles, p, particularly if some of the response tuples, c, are uncommon. For the CWL, there are four interesting combinations of trials that provide a useful dissection of memory performance. The first three immediate free recall trials provide response tuples that measure working memory performance in the prefrontal cortex. The delayed free recall trial response tuples provide a measure of hippocampal storage and retrieval combined. The delayed recognition trial response tuples provide a measure of hippocampal storage. The first four trials or all five trials combined provide overall measures of memory performance.

For the four-trial CWL response tuples, one needs thousands of cases to obtain adequate estimates of each possible response tuple for each word. A database of cases can be built for this purpose, in which group membership is not explicitly known but can be reasonably accurately estimated by a previously established, validated algorithm (see e.g., Cho A, Sugimura M, Nakano S, Yamada T. Early Detection and Diagnosis of MCI Using the MCI Screen Test. The Japanese Journal of Clinical and Experimental Medicine. 2007; 84(8):1152-1160; Trenkle D, Shankle W R, Azen S P. Detecting Cognitive Impairment in Primary Care Performance Assessment of Three Screening Instruments. Journal of Alzheimer's Disease. 2007; 11(3):323-335; and Shankle, W. R., Romney, A. K., Hara, J., Fortier, D., Dick, M., Chen, J., Chan, T., Sun, S., “Method to improve the detection of mild cognitive impairment”, PNAS, Vol. 102, No. 13, pp. 4919-4924, 2005).

Group membership of each case in the database can be independently determined twice by the algorithm, first using a high sensitivity cut-point (e.g., Sn=96%, Sp=88%), which identifies a relatively pure sample of normal cases, and then using a high specificity cut-point (e.g., Sn=83%, Sp=98%), which identifies a relatively pure sample of impaired cases. The performance of the group membership probability estimates derived from equation (2) can then be evaluated by each of these two cut-points for each response tuple of each word. This evaluation can be accomplished using each set of probability estimates independently to classify a different sample of subjects with known group membership. Note that an implicit presumption of this method is that the classification error attributable to the previously established algorithm is random relative to the response tuples.

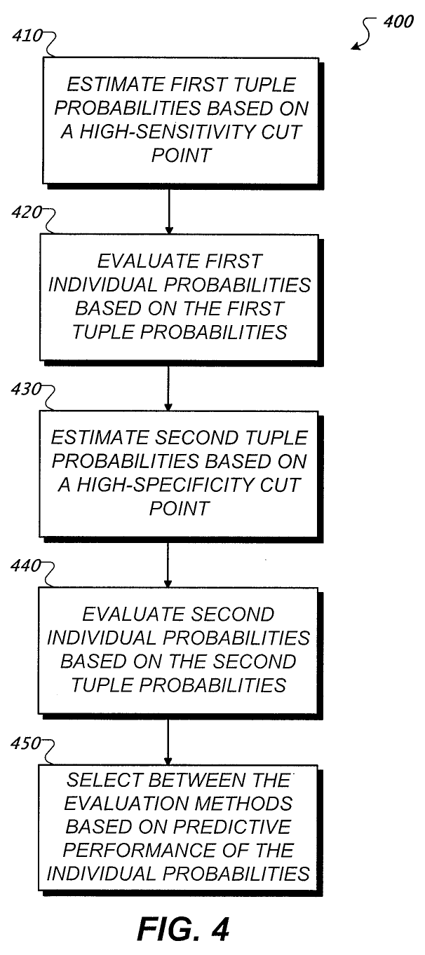

FIG. 4 shows an example process 400 of identifying one or more response tuples that discriminate between a first condition and a second condition of the brain, such as a mild cognitive impairment condition or a normal condition. For each response tuple, a first tuple probability associated with the first and second conditions can be estimated 410 based on a high sensitivity cut-point applied to the information for a group of people. For example, an existing algorithm (such as noted above) can be applied with high sensitivity to a large data set, D, to assign group membership to each subject. Then, equation (2) above can be used to compute the probability of group membership for each response tuple of each word.

For each individual in a sample, a first individual probability associated with the first and second conditions can be evaluated 420 based on the first tuple probabilities for response tuples associated with the individual. For example, equation (1) above can be used to compute each subject's probability of membership to each group. In addition, the odds ratio between the two conditions (e.g., impaired versus normal) can be computed for each subject, P(aᵢ=1|Dᵢ)/P(aᵢ=0|Dᵢ). The natural logarithm of this odds ratio can be taken, and the resulting predicted classification can be compared with that predicted by the high sensitivity algorithm.

This process can be repeated using a high specificity algorithm. For each response tuple, a second tuple probability associated with the first and second conditions can be estimated 430 based on a high specificity cut-point applied to the information for the group of people. For each individual in the sample, a second individual probability associated with the first and second conditions can be evaluated 440 based on the second tuple probabilities for response tuples associated with the individual. These operations can employ equations (1) and (2), as was described for the case when group membership was assigned using the high sensitivity algorithm. Similarly, the odds ratio of between the two conditions (e.g., impaired versus normal) can be computed for each subject, P(aᵢ=1|Dᵢ)/P(aᵢ=0|Dᵢ), the natural logarithm of this can be taken, and the resulting predicted classification can be compared with that predicted by the high specificity algorithm.

A selection can be made 450, between evaluation based on the high sensitivity cut-point and evaluation based on the high specificity cut-point, based on whether the first individual probabilities or the second individual probabilities provide better predictive performance. In general, it can be determined which of these two methods gives the best prediction when applied to an independent sample of well-classified cases.

A detailed example is now provided in the context of distinguishing mild cognitive impairment and mild dementia from normal cognitive aging. In the CWL test, the learning trials require subjects to repeat each word after being exposed to it, and at the end of the ten-word list, to immediately recall as many words as they can (immediate free recall). There are three learning trials. After trial three, there is an interference task lasting two to five minutes, which is followed by a fourth free recall trial without exposure to the wordlist (delayed free recall). In the standard CWL test, the order of the list words changes with each learning trial. In the modified CWL test, the order of the list words need not change across learning trials.

The above test design results in 4 trials with 2⁴=16 response tuples per list word. Given that memory ability declines naturally over time, it is useful to estimate response tuple profiles separately for different age levels. Analysis of data on 43,471 normal aging subjects suggests that the following four age groups maximized the explained variance of the predictor score for the previously established algorithm: <50, 50-59, 60-79, and >80 years old.

Using the high sensitivity algorithm applied to 43,471 subjects, 40,274 were classified as normal and 3,197 were classified as impaired. For each age-by-classification group, the probabilities of the 16 response tuples for each list word were computed, and the group membership probabilities of each subject's response tuple profile were computed. The log-odds ratio of these group membership probabilities was then computed for each subject. This process was repeated using the high specificity algorithm.

To classify individuals with this algorithm, equation (1) was used within each age bracket. For example, the probability that the response tuple profile of a given subject, i, belongs to the impaired group is:

$$P ( {a}_{i} = 1 \vert {D}_{i} , {age}_{i} ) = \frac{P ( a = 1 \vert {age}_{i} ) P ( {D}_{i} \vert a = 1 , {age}_{i} )}{\begin{matrix}P ( a = 1 \vert age ) P ( {D}_{i} \vert a = 1 , {age}_{i} ) + \\ P ( a = 0 \vert {age}_{i} ) P ( {D}_{i} \vert a = 0 , {age}_{i} )\end{matrix}}$$

Where ageᵢ indicates the age group of individual i. To estimate response tuple profile prior probabilities for age groups with too few impaired cases (e.g., only 55 impaired subjects under 50 years old), a weighted combination of the cases within the range of interest, plus additional cases (e.g., two hundred or more) from a predetermined extended age range, can be used. For example, the <50 year-old age group used two hundred cases from an extended range of <65 years old to compute the response tuple profile prior probabilities.

In general, two situations can arise in which there are insufficient numbers of subjects to provide a reliable estimate. An estimate's reliability can be determined by computing the confidence interval for its odds ratio (impaired/normal), and comparing this confidence interval to those obtained for larger samples. The first situation involves estimating the probability of impairment for the response tuple profile and was illustrated above. It occurs when a target group has an insufficient number of classified individuals. In this situation, one can identify one or more groups (most similar groups) that are most similar (using an appropriate measure) to the target group. One can then use a weighted combination of the counts from the target and most similar groups to estimate the response tuple profiles. The quality of these estimates can be examined by using the counts from the most similar group to classify a set of data from the target group. If the most similar group classifies the target group data well, then it is permissible to use this group to augment the target group's category counts.

The second situation involves estimating the probability of impairment for a specific response tuple as determined by equation (2). It occurs when there are insufficient numbers for a given response tuple (target tuple). In this situation, one can identify other response tuples (most similar tuples) that are most similar (using an appropriate measure) to the target tuple, combine their samples, and compute the joint probability of the response tuples. This solution consequently reduces the final number of response tuples estimated. For example, in a four-trial test of free recall, suppose that the 4-tuple, (0,0,1,0), has an insufficient sample to reliably estimate the probability of impairment. However, one suspects that the 4-tuple, (0,1,0,0), provides similar evidence for impairment. These two tuples are then combined and their joint probability of impairment is computed. This would result in a total of 15 rather than 16 response tuple categories for each item. Other most similar tuples can be further combined as necessary so that the final set of response profiles can be sufficiently estimated given the classified individuals. The quality of the estimate for the joint set of response tuples can be checked by computing the binomial confidence interval for its odds ratio (impaired/normal). If this odds ratio confidence interval is similar to those obtained for response tuples with large samples, then it can be accepted. Otherwise, further estimation can be performed.

The performances of the two classification methods (based on different sets of estimated prior probabilities of the response tuple profiles) were validated against a sample of well-characterized cases from a university and a community based ADRD clinic. The superior of the two classification methods was then compared to results derived by an algorithm based on correspondence analysis and individual word scores. One comparison was made using data from a university ADRD clinic in which wordlist order differed for the three learning trials because the wordlist order was generally random (Random Order). A second comparison was made using data from a community ADRD clinic and a primary care clinic in which wordlist order was the same across all three learning trials (Fixed Order). A non-parametric estimation of the area under the ROC curve in each case is as follows: Correspondence Analysis with Fixed Order was 95%; Correspondence Analysis with Random Order was 97%; Response Tuple Analysis with Fixed Order was 96%; and Response Tuple Analysis with Random Order was 97%.

Thus, the response tuple analysis approach performs roughly the same on the Random Order data set, but a percentage point or better on the Fixed Order dataset. This improvement corresponds to a 20% increase ([96%−95%]/[100%−95%]) in the maximal possible increase for accuracy. This improvement can be attributed to the response tuple analysis approach's use of more of the cognitively relevant information contained in the recalled and non-recalled items as a function of item exposure.

Regardless of the type of brain condition being assessed, additional operations can be performed, and an odd ratio such as described above (e.g., a log of the odds ratio) can be included in a general linear or other classification model that allows incorporation of other potentially relevant factors such as age, gender, etc. Note that the odds ratio can have different meanings for different ages, genders, etc. Thus, the odds ratio can be included in a classification algorithm with other potentially relevant factors to perform a classification.

Note that such potentially relevant factors can also include information regarding the person's responses (and lack thereof) given during administration of the cognitive test. For example, the analysis groups used in the classification can be selected from the larger information set for the cognitive test based on the response to a given item in the test or based on other information from the tuples (e.g., only look at tuples with a 1 in the first position). Thus, any of a variety of categories could be used to define the analysis, including age and gender (as noted above), but also including specific responses on the test and cross-distribution among responses on the test.

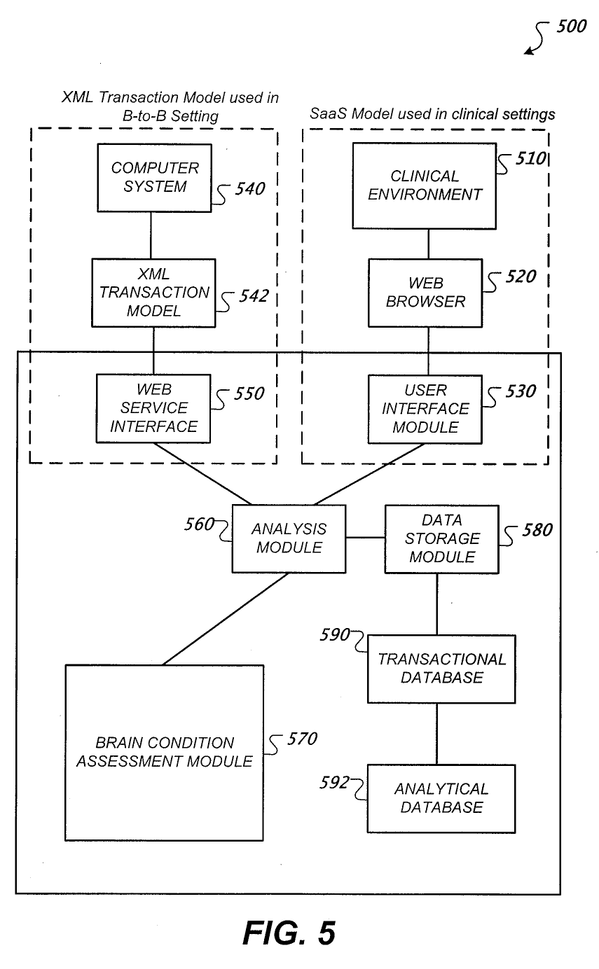

FIG. 5 shows another example system 500 used to create an indication of brain condition. The example system described can perform a variety of functions including data analysis, storage and viewing, and remote access and storage capabilities useful for generating and using an indication of brain condition. The indication of brain condition can be determined using the methods described elsewhere in this specification.

A Software as a Service (SaaS) model can provide network based access to the software used to create an indication of brain condition. This central management of the software can provide advantages, which are well known in the art, such as offloading maintenance and disaster recovery to the provider. A user, for example, a test administrator within a clinical environment 510, can access test administration software within the test administration system via a web browser 520. A user interface module 530 receives and responds to the test administrator interaction.

In addition, a customer's computer system 540 can access software and interact with the test administration system using an eXtensible Markup Language (XML) transactional model 542. The XML framework provides a method for two parties to send and receive information using a standards-based, but extensible, data communication model. A web service interface 550 receives and responds to the customer computer system 540 in XML format. For example, an XML transactional model can be useful for storage and retrieval of the structured data relating to the cognitive function index.

An analysis module 560 analyses inputs from the web service interface 550 and the user face module 530, and produces test results to send. The analysis module uses a brain condition assessment module 570 to perform the test analysis. The brain condition assessment module 570 can, for example, incorporate the methods described elsewhere in this specification.

A data storage module 580 transforms the test data collected by the user interface module 530, web service interface 550, and the resulting data generated by the analysis module 560 for permanent storage. A transactional database 590 stores data transformed and generated by the data storage module 580. For example, the transactional database can keep track of individual writes to a database, leaving a record of transactions and providing the ability to roll back the database to a previous version in the event of an error condition. An analytical database 592 can store data transformed and generated by the data storage module 580 for data mining and analytical purposes.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal that is generated to encode information for transmission to suitable receiver apparatus for execution by a computer. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a cross-platform runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results. The actions recited in the claims can be performed using different statistical classification procedures, such as discriminant analysis, stepwise multivariate regression or general linear models, rather than logistic regression as described above. The actions recited in the claims can be performed using different orthogonal transformations of the raw input data, such as principal components analysis, multi-dimensional scaling, or latent variable analysis, rather than correspondence analysis as described above.

Moreover, the unit of analysis that is common to a plural subset of the trials, and which is tracked across those trials, need not correspond to the same item. For example, the commonality can be position within the respective trials (e.g., the item can be the second one presented in each learning trial even when the second item presented differs across trials).

For cognitive tests that do not involve multiple trials, such as the Boston Naming, Category Fluency, Letter Fluency, Trails A and B, CERAD Drawing, and Ishihara Number Naming tests, the unit of analysis may correspond to an attribute of the items. For example, for the Category Fluency test and other tests of word generation, the commonality can be the semantic distance between words correctly retrieved. For visual perceptual tests such as the CERAD Drawing task, the commonality can be accuracy for the drawing of lines vs. angles vs. curves. For an object recognition task such as the Ishihara Color Plates Number Naming test, the commonality can be the similarity of the shapes of digits 0-9 (e.g., 3 and 8 are similar, 6 and 9 are similar, 1 and 7 are similar, etc.). For a test of executive function such as the Trails B test, the commonality can be the accuracy of connecting to the next number or letter in the sequence (e.g., 1 connects to A, A connects to 2, 2 connects to B, B connects to 3, etc.). These examples are intended to illustrate that the unit of analysis need not be the same item but can be any attribute that is potentially relevant to assessment of task performance.

Other implementations of the invention can also be applied to tests measuring behavior such as the Neuropsychiatric Inventory. For example, the unit of analysis for the Neuropsychiatric Inventory can be the conditional probability of aggressive behavior given the state of agitation, hallucinations, delusions and sleep behavior of the patient.

Other implementations of the invention can also be applied to tests measuring functional capacity such as the Disability Assessment for Dementia or the ADCS-ADL questionnaires. For example, the unit of analysis for the ADCS-ADL can be the conditional probability, or tupling, of activities of daily living that correspond, respectively, to FAST stages 4 (cooking, cleaning, shopping), 5 (making judgments) and 6 (bathing, dressing toileting).

Other implementations of the invention can also be applied to tests assessing potential diagnostic cause(s) of a patient's brain condition, such as the apolipoprotein E genotype, brain imaging (CT, MRI, PET), B12, folate, homocysteine, LDL and HDL cholesterol, triglycerides, and ANA titer. For example, the unit of analysis for MRI can be the conditional probability, or tupling, of specific brain regions such as entorhinal cortex, hippocampus, posterior cingulated gyrus, posterior parietal lobe, anterior cingulate cortex, superior temporal lobule, prefrontal cortex, centrum semiovale, periventricular white matter, basal ganglia, brainstem and cerebellum. Another example implementation can look at the tupling of homocysteine, B12, folate, ANA titer, while another example can look at the tupling of LDL, HDL, Triglycerides and Apolipoprotein E genotype. These examples illustrate that the unit of analysis can be applied to tests of cognitive, functional and behavioral capacity, as well as to tests diagnosing the underlying etiology of a patient's brain condition.

1. A computer-implemented method comprising:
receiving first information concerning a person, the first information specifying the person's responses, and lack thereof, for items of a cognitive test administered to the person, wherein the cognitive test comprises multiple item-recall trials and includes at least one item common to a subset of the recall trials, the subset comprising at least two of the recall trials;
generating an indication of brain condition for the person by comparing the first information with second information concerning a group of people to whom the cognitive test has been administered, wherein the comparing comprises checking a conditional probability of recalling the at least one item in one recall trial of the subset when the at least one item has been recalled in another recall trial of the subset; and
outputting the indication of brain condition for the person.

2. The method of claim 1, comprising determining a recall pattern for each of multiple items across the recall trials, and wherein the comparing comprises evaluating a probability of the recall patterns for the person given probabilities of the recall patterns for the group of people.

3. The method of claim 1, wherein generating the indication of brain condition for the person comprises choosing between evaluation techniques based on response tuples that discriminate between a first condition and a second condition of the brain, wherein the choosing comprises:
estimating, for each response tuple, a first tuple probability associated with the first and second conditions based on a high sensitivity cut-point applied to the second information;
evaluating, for each individual in a sample, a first individual probability associated with the first and second conditions based on the first tuple probabilities for response tuples associated with the individual;
estimating, for each response tuple, a second tuple probability associated with the first and second conditions based on a high specificity cut-point applied to the second information;
evaluating, for each individual in the sample, a second individual probability associated with the first and second conditions based on the second tuple probabilities for response tuples associated with the individual; and
selecting, between evaluation based on the high sensitivity cut-point and evaluation based on the high specificity cut-point, based on whether the first individual probabilities or the second individual probabilities provide better predictive performance.

4. The method of claim 3, wherein the first condition comprises mild cognitive impairment, the second condition comprises normal cognitive function, and generating the indication of brain condition comprises generating a cognitive function measure that indicates whether the person is likely to have mild cognitive impairment.

5. The method of claim 3, wherein the first condition comprises mild dementia, the second condition comprises normal cognitive function, and generating the indication of brain condition comprises generating a cognitive function measure that indicates whether the person is likely to have mild dementia.

6. The method of claim 3, wherein the first condition comprises mild dementia, the second condition comprises mild cognitive impairment, and generating the indication of brain condition comprises generating a cognitive function measure that indicates whether the person is likely to have mild dementia versus mild cognitive impairment.

7. The method of claim 3, wherein the estimating the first tuple probability and the estimating the second tuple probability are performed with respect to a proper subset of the second information, and the sample comprises an independent sample taken from the second information, excluding individuals in the proper subset.

8. A computer-readable medium encoding a computer program product operable to cause data processing apparatus to perform operations comprising:
receiving first information concerning a person, the first information specifying the person's responses, and lack thereof, for items of a cognitive test administered to the person, wherein the cognitive test comprises multiple item-recall trials and includes at least one item common to a subset of the recall trials, the subset comprising at least two of the recall trials;
generating an indication of brain condition for the person by comparing the first information with second information concerning a group of people to whom the cognitive test has been administered, wherein the comparing comprises checking a conditional probability of recalling the at least one item in one recall trial of the subset when the at least one item has been recalled in another recall trial of the subset; and
outputting the indication of brain condition for the person.

9. The computer-readable medium of claim 8, the operations comprising determining a recall pattern for each of multiple items across the recall trials, and wherein the comparing comprises evaluating a probability of the recall patterns for the person given probabilities of the recall patterns for the group of people.

10. The computer-readable medium of claim 8, wherein generating the indication of brain condition for the person comprises choosing between evaluation techniques based on response tuples that discriminate between a first condition and a second condition of the brain, wherein the choosing comprises:
estimating, for each response tuple, a first tuple probability associated with the first and second conditions based on a high sensitivity cut-point applied to the second information;
evaluating, for each individual in a sample, a first individual probability associated with the first and second conditions based on the first tuple probabilities for response tuples associated with the individual;
estimating, for each response tuple, a second tuple probability associated with the first and second conditions based on a high specificity cut-point applied to the second information;
evaluating, for each individual in the sample, a second individual probability associated with the first and second conditions based on the second tuple probabilities for response tuples associated with the individual; and
selecting, between evaluation based on the high sensitivity cut-point and evaluation based on the high specificity cut-point, based on whether the first individual probabilities or the second individual probabilities provide better predictive performance.

11. The computer-readable medium of claim 10, wherein the first condition comprises mild cognitive impairment, the second condition comprises normal cognitive function, and generating the indication of brain condition comprises generating a cognitive function measure that indicates whether the person is likely to have mild cognitive impairment.

12. The computer-readable medium of claim 10, wherein the first condition comprises mild dementia, the second condition comprises normal cognitive function, and generating the indication of brain condition comprises generating a cognitive function measure that indicates whether the person is likely to have mild dementia.

13. The computer-readable medium of claim 10, wherein the first condition comprises mild dementia, the second condition comprises mild cognitive impairment, and generating the indication of brain condition comprises generating a cognitive function measure that indicates whether the person is likely to have mild dementia versus mild cognitive impairment.

14. The computer-readable medium of claim 10, wherein the estimating the first tuple probability and the estimating the second tuple probability are performed with respect to a proper subset of the second information, and the sample comprises an independent sample taken from the second information, excluding individuals in the proper subset.

15. A system comprising:
a user interface device; and
one or more computers operable to interact with the user interface device and to perform operations comprising:
receiving first information concerning a person, the first information specifying the person's responses, and lack thereof, for items of a cognitive test administered to the person, wherein the cognitive test comprises multiple item-recall trials and includes at least one item common to a subset of the recall trials, the subset comprising at least two of the recall trials;
generating an indication of brain condition for the person by comparing the first information with second information concerning a group of people to whom the cognitive test has been administered, wherein the comparing comprises checking a conditional probability of recalling the at least one item in one recall trial of the subset when the at least one item has been recalled in another recall trial of the subset; and
outputting the indication of brain condition for the person.

16. The system of claim 15, the operations comprising determining a recall pattern for each of multiple items across the recall trials, and wherein the comparing comprises evaluating a probability of the recall patterns for the person given probabilities of the recall patterns for the group of people.

17. The system of claim 15, wherein generating the indication of brain condition for the person comprises choosing between evaluation techniques based on response tuples that discriminate between a first condition and a second condition of the brain, wherein the choosing comprises:
estimating, for each response tuple, a first tuple probability associated with the first and second conditions based on a high sensitivity cut-point applied to the second information;
evaluating, for each individual in a sample, a first individual probability associated with the first and second conditions based on the first tuple probabilities for response tuples associated with the individual;
estimating, for each response tuple, a second tuple probability associated with the first and second conditions based on a high specificity cut-point applied to the second information;
evaluating, for each individual in the sample, a second individual probability associated with the first and second conditions based on the second tuple probabilities for response tuples associated with the individual; and
selecting, between evaluation based on the high sensitivity cut-point and evaluation based on the high specificity cut-point, based on whether the first individual probabilities or the second individual probabilities provide better predictive performance.

18. The system of claim 17, wherein the first condition comprises mild cognitive impairment, the second condition comprises normal cognitive function, and generating the indication of brain condition comprises generating a cognitive function measure that indicates whether the person is likely to have mild cognitive impairment.

19. The system of claim 17, wherein the first condition comprises mild dementia, the second condition comprises normal cognitive function, and generating the indication of brain condition comprises generating a cognitive function measure that indicates whether the person is likely to have mild dementia.

20. The system of claim 17, wherein the first condition comprises mild dementia, the second condition comprises mild cognitive impairment, and generating the indication of brain condition comprises generating a cognitive function measure that indicates whether the person is likely to have mild dementia versus mild cognitive impairment.

21. The system of claim 17, wherein the estimating the first tuple probability and the estimating the second tuple probability are performed with respect to a proper subset of the second information, and the sample comprises an independent sample taken from the second information, excluding individuals in the proper subset.
